(19) United States
(12) Patent Application Publication
(10) Pub. No.: US 2024/0186576 A1
(43) Pub. Date: Jun. 6, 2024

(54) ELECTROLYTE ADDITIVE, ELECTROLYTE AND LITHIUM-ION SECONDARY BATTERY CONTAINING SAME, AND USE THEREOF

(71) Applicant: MURATA MANUFACTURING CO., LTD., Kyoto (JP)

(72) Inventors: Manli XUE, Shanghai (CN); Haoyue ZHONG, Shanghai (CN); Yingtao CHEN, Shanghai (CN); Cheng ZHU, Shanghai (CN); Fan YANG, Shanghai (CN)

(21) Appl. No.: 18/428,403

(22) Filed: Jan. 31, 2024

Related U.S. Application Data
(63) Continuation of application No. PCT/CN2022/108022, filed on Jul. 26, 2022.

(30) Foreign Application Priority Data
Aug. 5, 2021 (CN) 202110895913.4

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/0037

(57) ABSTRACT

An electrolyte additive, an electrolyte and a lithium-ion secondary battery containing same, and the use thereof are provided. The electrolyte additive includes a compound as represented by a formula (1) as follows:

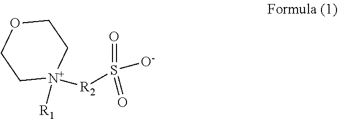

wherein R₁ is a substituted or unsubstituted C₁₋₆ alkyl group, and R₂ is selected from the group consisting of a substituted or unsubstituted C₁₋₆ aliphatic hydrocarbylene groups and a 6-10 membered substituted or unsubstituted carbocyclic or heterocyclic aromatic group, wherein the heterocyclic aromatic group comprises 1 to 3 heteroatoms selected from N, S, O or any combination thereof.

### CROSS REFERENCE TO RELATED APPLICATIONS

The present application is a continuation of PCT patent application no. PCT/CN2022/108022, filed on Jul. 26, 2022, which claims priority to Chinese patent application no. 202110895913.4, filed on Aug. 5, 2021, the entire contents of which are incorporated herein by reference.

### BACKGROUND

The present application relates to a lithium-ion secondary battery, and in particular, to an electrolyte additive, an electrolyte and a lithium-ion secondary battery containing same, and the use thereof.

With the rapid development of economy and society, there are also more urgent requirements for lithium-ion batteries with a high energy density and a long cycle life. High nickel/silicon-carbon type lithium ion batteries are considered to be a viable solution to the current problem. However, the high nickel type positive electrode and the silicon-carbon type negative electrode have insufficient structural stability in electric cycles, which may cause serious deterioration of battery performance under conditions of a high temperature and a high rate.

During charging and discharging of a lithium-ion battery, a solvent may be decomposed, and a compound obtained from decomposition will form a positive electrode electrolyte interface film (CEI film) on the positive electrode surface of the battery, and will form a solid electrolyte interface film (SEI film) on the negative electrode surface of the battery. The CEI film and the SEI film can effectively suppress further reaction of the solvent with the electrodes. However, during the electric cycle, the structure of the high-nickel positive electrode is unstable, and the CEI film is easily destroyed, thereby causing the dissolution of transition metal ions. In addition, the silicon negative electrode material is likely to undergo volume expansion during charging and discharging, causing the SEI film to be broken, so that the electrode structure collapses, and the battery performance is significantly reduced.

At present, a common method for improving the battery performance is to add various film-forming additives to an electrolyte so as to form a stable protective interface (a CEI film and an SEI film) on the surface of the positive electrode and the negative electrode, respectively. For example, such film-forming additives include phosphates, nitriles, and sulfonate compounds. During the first charge/discharge cycle, the decomposition reaction of the film-forming additives takes place preferentially over the solvent, and the decomposition product thereof forms a stable and dense SEI film on the surface of the positive electrode. In addition, in order to protect the negative electrode, it is necessary to add a film-forming additive such as a borate salt, a lithium salt containing nitrogen, or a carbonate, so as to form a stable negative electrode SEI film on the surface of the negative electrode during the first charge/discharge cycle. However, in order to protect the positive electrode and the negative electrode at the same time, a plurality of additives need to be used in combination at the same time, which will introduce more impurities, initiate side reactions, and increase the controllability of the reaction process. Minimizing the types of additives and controlling the amount of additives are key points for improving battery performance. Therefore, in order to solve the described problems, for example, there is still a need to develop an electrolyte additive capable of effectively forming an SEI film and a CEI film and ensuring the electric performance of a lithium-ion secondary battery.

### SUMMARY

The present application, in an embodiment, relates to providing an electrolyte additive, an electrolyte and a lithium-ion secondary battery containing same, and the use thereof, so as to solve the problem that the combined use of a plurality of electrolyte additives introduces more impurities, initiates side reactions, and increases the controllability of the reaction process.

According to an embodiment of the present application, an electrolyte additive is provided and includes a compound as represented by the following formula (1):

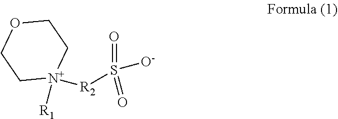

wherein R₁ is a substituted or unsubstituted C₁₋₆ alkyl group, and R₂ is selected from the group consisting of substituted or unsubstituted C₁₋₆ aliphatic hydrocarbylene groups and 6-10 membered substituted or unsubstituted carbocyclic or heterocyclic aromatic groups, wherein the heterocyclic aromatic group comprises 1 to 3 heteroatoms selected from N, S, O or any combination thereof.

Further, in the electrolyte additive, in an embodiment, R₁ is a C₁₋₃ alkyl group substituted with a halogen or a C₁₋₃ alkyl group.

Further, in the electrolyte additive, in an embodiment, R₂ is selected from the group consisting of C₁₋₆ alkylene groups, C₁₋₆ alkylene groups substituted with a halogen or a C₁₋₃ alkyl group, phenylene group, phenylene groups substituted with a halogen or a C₁₋₃ alkyl group, benzothiazolylene group, and benzothiazolylene groups substituted with a halogen or a C₁₋₃ alkyl group.

Further, in the electrolyte additive, in an embodiment, the compound as represented by Formula (1) is any one of the following:

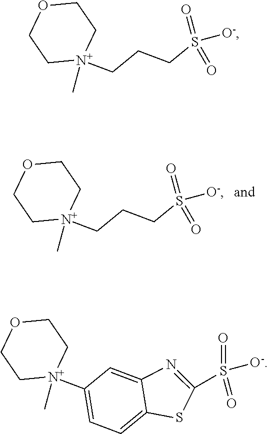

According to another embodiment of the present application, an electrolyte is provided and includes an organic solvent, a lithium salt, and the electrolyte additive described herein.

Further, in an embodiment, the amount of the electrolyte additive is in the range of 0.1 parts by weight to 1 part by weight based on 100 parts by weight of the total weight of the organic solvent and the lithium salt.

Further, in electrolyte, in an embodiment, the amount of the electrolyte additive is in the range of 0.1 parts by weight to 0.5 parts by weight based on 100 parts by weight of the total weight of the organic solvent and the lithium salt.

Further, in the electrolyte, in an embodiment, the lithium salt is selected from the group consisting of LiPF₆, LiBF₄, LiAsF₆, LiCF₃SO₃, LiN(SO₂F)₂, LiN(SO₂CF₃)₂, LiC(SO₂CF₃)₃, Li₂SiF₆, or any combination thereof.

Further, in electrolyte, in an embodiment, the organic solvent is selected from the group consisting of propylene carbonate, butylene carbonate, fluoroethylene carbonate, diethyl carbonate, dipropyl carbonate, methylethyl carbonate, ethylene carbonate, dimethyl carbonate, or any combination thereof.

According to yet another embodiment of the present application, a lithium-ion secondary battery is provided and includes a positive electrode sheet, a negative electrode sheet, a separator, and the above-mentioned electrolyte.

According to yet another embodiment of the present application, the use of the electrolyte additive is provided for preparing one or both of an electrolyte for a lithium-ion secondary battery and a lithium-ion secondary battery.

Due to the electrolyte additive, the electrolyte containing same, the lithium-ion secondary battery, and the use thereof, the technical effects of improving electrode stability, reducing battery impedance, and improving high-temperature cycle performance and rate performance of a battery are achieved according to an embodiment of the present application.

### BRIEF DESCRIPTION OF THE FIGURES

FIG. 1 shows the results of the rate discharge test of Example 2, Example 5, and Comparative Example 1; and

FIG. 2 shows the results of the float charging test of Example 2, Example 5, and Comparative Example 1.

### DETAILED DESCRIPTION

The present application will be described in further detail below including with reference to examples according to an embodiment and in any suitable combination and modification thereof.

As explained in the background, in a lithium-ion secondary battery, a variety of electrolyte additives are generally used in combination to form a CEI film and an SEI film on the positive electrode and the negative electrode, respectively. However, this process will introduce more impurities, initiate side reactions, and increase the controllability of the reaction process. In view of such problems, for example, the present application provides, in an embodiment, an electrolyte additive comprising a compound as represented by the following formula (1):

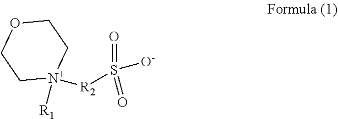

wherein R₁ is a substituted or unsubstituted C₁₋₆ alkyl group, and R₂ is selected from the group consisting of substituted or unsubstituted C₁₋₆ aliphatic hydrocarbylene groups and 6-10 membered substituted or unsubstituted carbocyclic or heterocyclic aromatic groups, wherein the heterocyclic aromatic group comprises 1 to 3 heteroatoms selected from N, S, O, or any combination thereof.

According to the present application, in an embodiment, in the case where the compound of the Formula (1) is used as an electrolyte additive, during the first cycle of the lithium-ion secondary battery, decomposition can be prioritized over the electrolyte, and at the same time, a solid electrolyte film is formed on both the positive electrode and the negative electrode, that is, a CEI film is effectively formed on the positive electrode and an SEI film is effectively formed on the negative electrode.

In an embodiment, the compound of Formula (1) is selected as an internal salt compound, and different groups in the molecule have positive charges and negative charges, but the overall performance is electrically neutral. The positively charged morpholinyl moiety exhibits a strong electron-withdrawing effect, and can form a stable SEI film on the surface of the negative electrode in the case of being decomposed into morpholine radical ions. Meanwhile, the negatively charged sulphonic acid group exhibits a strong electron-donating effect, and can be oxidized on the surface of the positive electrode to form a stable CEI film in the case of being decomposed into sulphonic acid group ions. The internal salt compound of formula (1) of the present application can form an interface protection film on the surface of the positive electrode and the negative electrode at the same time, so that the reaction between the solvent and the electrodes is effectively avoided, the dissolution of metal ions is inhibited, the stability of the electrodes is effectively improved, the impedance of the battery is reduced, and the cycle retention rate and the rate performance of the battery are improved. In addition, in the case of using the compound of formula (1) of the present application, only one electrolyte can be added without adding various additives at the same time to form a solid electrolyte film on the positive electrode and the negative electrode at the same time, thus eliminating the possibility of side reactions occurring between the electrolyte additives, so as to effectively control the formation of impurities on the surface of the electrolyte and the electrode, thereby reducing the impedance of the battery.

During the first cycle of the battery, due to the production of the hydrolysis product HF, the compound of Formula (1) is decomposed into positively charged morpholine radical ions and negatively charged sulfate ions under the action of HF. Positively charged morpholine radicals bind transition metal ions Mⁿ⁺ to the positive electrode surface of the battery, and form a stable CEI film on the positive electrode surface after circulation, so as to suppress the dissolution of the transition metal. The morpholine radicals have a cyclic structure, and thus can cover the positive electrode more effectively, thereby protecting the positive electrode material from reacting with the electrolyte, avoiding the reaction of the solvent and the electrodes, and inhibiting the dissolution of the metal ions. The negatively charged sulfate ions constantly react after the negative electrode is supplied with electrons to form a network-like SEI film, thereby improving the cycle performance and the rate performance of the battery.

In one or more embodiments, R₁ in Formula (1) can be selected from methyl, ethyl, n-propyl, isopropyl, n-butyl, isobutyl, neobutyl, n-pentyl, isopentyl, neopentyl, n-hexyl, isohexyl, or neohexyl. In one or more embodiments, R₂ in formula (1) can be selected from the group consisting of C₁₋₆ linear aliphatic hydrocarbylene groups, monocyclic or bicyclic aromatic groups, and heterocyclic aromatic groups containing a bicyclic ring. In a preferred embodiment, R₂ can be selected from the group consisting of C₁₋₆ alkylene groups, C₁₋₆ alkenylene groups, C₁₋₆ alkynylene groups, phenylene, naphthylene, benzothiazolylene, benzofurylene, benzothienyl, and benzopyrazolyl. In other embodiments, R₂ can also be selected from C₃₋₆ alicyclic hydrocarbylene groups.

In one or more embodiments, the electrolyte additive of Formula (1) includes one of the following substituted or unsubstituted compounds or any combination thereof: N-methyl-N-(3-methanesulfonate)morpholine, N-ethyl-N-(3-methanesulfonate)morpholine, N-n-propyl-N-(3-methanesulfonate)morpholine, N-isopropyl-N-(3-methanesulfonate)morpholine, N-n-butyl-N-(3-methanesulfonate)morpholine, N-isobutyl-N-(3-methanesulfonate)morpholine, N-tert-butyl-N-(3-methanesulfonate)morpholine, N-n-pentyl-N-(3-methanesulfonate)morpholine, N-isopentyl-N-(3-methanesulfonate)morpholine, N-neopentyl-N-(3-methanesulfonate)morpholine, N-n-hexyl-N-(3-methanesulfonate)morpholine, N-isohexyl-N-(3-methanesulfonate)morpholine, N-neohexyl-N-(3-methanesulfonate)morpholine, N-methyl-N-(3-ethanesulfonate)morpholine, N-ethyl-N-(3-ethanesulfonate)morpholine, N-n-propyl-N-(3-ethanesulfonate)morpholine, N-isopropyl-N-(3-ethanesulfonate)morpholine, N-n-butyl-N-(3-ethanesulfonate)morpholine, N-isobutyl-N-(3-ethanesulfonate)morpholine, N-tert-butyl-N-(3-ethanesulfonate)morpholine, N-pentyl-N-(3-ethanesulfonate)morpholine, N-isopentyl-N-(3-ethanesulfonate)morpholine, N-neopentyl-N-(3-ethanesulfonate)morpholine, N-n-hexyl-N-(3-ethanesulfonate)morpholine, N-isohexyl-N-(3-ethanesulfonate)morpholine, N-neohexyl-N-(3-ethanesulfonate)morpholine, N-methyl-N-(3-propanesulfonate)morpholine, N-ethyl-N-(3-propanesulfonate)morpholine, N-n-propyl-N-(3-propanesulfonate)morpholine, N-isopropyl-N-(3-propanylsulfonate)morpholine, N-n-butyl-N-(3-propanesulfonate)morpholine, N-isobutyl-N-(3-propanesulfonate)morpholine, N-tert-butyl-N-(3-propanesulfonate)morpholine, N-pentyl-N-(3-propanesulfonate)morpholine, N-isopentyl-N-(3-propanesulfonate)morpholine, N-neopentyl-N-(3-propanesulfonate)morpholine, N-n-hexyl-N-(3-propanesulfonate)morpholine, N-isohexyl-N-(3-propanesulfonate)morpholine, N-neohexyl-N-(3-propanesulfonate)morpholine, N-methyl-N-(3-butanesulfonate)morpholine, N-ethyl-N-(3-butanesulfonate)morpholine, N-propyl-N-(3-butanesulfonate)morpholine, N-isopropyl-N-(3-butanesulfonate)morpholine, N-n-butyl-N-(3-butanesulfonate)morpholine, N-isobutyl-N-(3-butanesulfonate)morpholine, N-tert-butyl-N-(3-butanesulfonate)morpholine, N-pentyl-N-(3-butanesulfonate)morpholine, N-isopentyl-N-(3-butanesulfonate)morpholine, N-neopentyl-N-(3-butanesulfonate)morpholine, N-n-hexyl-N-(3-butanesulfonate)morpholine, N-isohexyl-N-(3-butanesulfonate)morpholine, N-neohexyl-N-(3-butanesulfonate)morpholine, N-methyl-N-(3-pentanesulfonate)morpholine, N-methyl-N-(3-hexanesulfonate)morpholine, N-ethyl-N-(3-pentanesulfonate)morpholine, or N-ethyl-N-(3-hexanesulfonate)morpholine.

In one or more embodiments, the electrolyte additive of Formula (1) includes one of the following substituted or unsubstituted compounds or any combination thereof: N-methyl-N-phenylmorpholine p-sulfonate, N-ethyl-N-phenylmorpholine p-sulfonate, N-n-propyl-N-phenylmorpholine p-sulfonate, N-isopropyl-N-phenylmorpholine p-sulfonate, N-n-butyl-N-phenylmorpholine p-sulfonate, N-isobutyl-N-phenylmorpholine p-sulfonate, N-tert-butyl-N-phenylmorpholine p-sulfonate, N-n-pentyl-N-phenylmorpholine p-sulfonate, N-isopentyl-N-phenylmorpholine p-sulfonate, N-neopentyl-N-phenylmorpholine p-sulfonate, N-n-hexyl-N-phenylmorpholine p-sulfonate, N-isohexyl-N-phenylmorpholine p-sulfonate, N-neohexyl-N-phenylmorpholine p-sulfonate, N-methyl-N-(2′-methyl-4′-sulfonate-phenyl-1′)-morpholine, N-methyl-N-(2′-ethyl-4′-sulfonate-phenyl-1′)-morpholine, N-methyl-N-(3′-methyl-4′-sulfonate-phenyl-1′)-morpholine, N-methyl-N-(3′-ethyl-4′-sulfonate-phenyl-1′)-morpholine, N-methyl-N-(2′,3′-dimethyl-4′-sulfonate-phenyl-1′)-morpholine, N-methyl-N-(2′,5′-dimethyl-4′-sulfonate-phenyl-1′)-morpholine, N-methyl-N-(2′,6′-dimethyl-4′-sulfonate-phenyl-1′)-morpholine, N-methyl-N-(2′,3′,5′-trimethyl-4′-sulfonate-phenyl-1′)-morpholine, N-methyl-N-(2′,3′,6′-trimethyl-4′-sulfonate-phenyl-1′)-morpholine, N-methyl-N-(2′,3′,5′,6′-tetramethyl-4′-sulfonate-phenyl-1′)-morpholine, N-ethyl-N-(2′-methyl-4′-sulfonate-phenyl-1′)-morpholine, N-ethyl-N-(2′-ethyl-4′-sulfonate-phenyl-1′)-morpholine, N-ethyl-N-(3′-methyl-4′-sulfonate-phenyl-1′)-morpholine, N-ethyl-N-(3′-ethyl-4′-sulfonate-phenyl-1′)-morpholine, N-ethyl-N-(2′,3′-dimethyl-4′-sulfonate-phenyl-1′)-morpholine, N-ethyl-N-(2′,5′-dimethyl-4′-sulfonate-phenyl-1′)-morpholine, N-ethyl-N-(2′,6′-dimethyl-4′-sulfonate-phenyl-1′)-morpholine, N-ethyl-N-(2′,3′,5′-trimethyl-4′-sulfonate-phenyl-1′)-morpholine, N-ethyl-N-(2′,3′,6′-trimethyl-4′-sulfonate-phenyl-1′)-morpholine, N-ethyl-N-(2′,3′,5′,6′-tetramethyl-4′-sulfonate-phenyl-1′)-morpholine, N-propyl-N-(2′-methyl-4′-sulfonate-phenyl-1′)-morpholine, N-propyl-N-(2′-ethyl-4′-sulfonate-phenyl-1′)-morpholine, N-propyl-N-(3′-methyl-4′-sulfonate-phenyl-1′)-morpholine, N-propyl-N-(3′-ethyl-4′-sulfonate-phenyl-1′)-morpholine, N-propyl-N-(2′,3′-dimethyl-4′-sulfonate-phenyl-1′)-morpholine, N-propyl-N-(2′,5′-dimethyl-4′-sulfonate-phenyl-1′)-morpholine, N-propyl-N-(2′,6′-dimethyl-4′-sulfonate-phenyl-1′)-morpholine, N-propyl-N-(2′,3′,5′-trimethyl-4′-sulfonate-phenyl-1′)-morpholine, N-propyl-N-(2′,3′,6′-trimethyl-4′-sulfonate-phenyl-1′)-morpholine, or N-propyl-N-(2′,3′,5′,6′-tetramethyl-4′-sulfonate-phenyl-1′)-morpholine.

In one or more embodiments, the electrolyte additive of Formula (1) includes one of the following substituted or unsubstituted compounds or any combination thereof: N-methyl-N-benzothiazomorpholine p-sulfonate, N-ethyl-N-benzothiazomorpholine p-sulfonate, N-n-propyl-N-benzothiazomorpholine p-sulfonate, N-isopropyl-N-benzothiazomorpholine p-sulfonate, N-n-butyl-N-benzothiazomorpholine p-sulfonate, N-isobutyl-N-benzothiazomorpholine p-sulfonate, N-tert-butyl-N-benzothiazomorpholine p-sulfonate, N-n-pentyl-N-benzothiazomorpholine p-sulfonate, N-isopentyl-N-benzothiazomorpholine p-sulfonate, N-neopentyl-N-benzothiazomorpholine p-sulfonate, N-n-hexyl-N-benzothiazomorpholine p-sulfonate, N-isohexyl-N-benzothiazomorpholine p-sulfonate, N-neohexyl-N-benzothiazomorpholine p-sulfonate, N-methyl-N-(2′-methyl-5′-sulfonate-benzothiazole-1′)morpholine, N-methyl-N-(8′-methyl-5′-sulfonate-benzothiazole-1′)morpholine, N-methyl-N-(9′-methyl-5′-sulfonate-benzothiazole-1′)morpholine, N-methyl-N-(2′-ethyl-5′-sulfonate-benzothiazole-1′)morpholine, N-methyl-N-(8′-ethyl-5′-sulfonate-benzothiazole-1′)morpholine, N-methyl-N-(9′-ethyl-5′-sulfonate-benzothiazole-1′)morpholine, N-methyl-N-(2′,8′-dimethyl-5′-sulfonate-benzothiazole-1′)morpholine, N-methyl-N-(8′,9′-dimethyl-5′-sulfonate-benzothiazole)-1′)morpholine, N-methyl-N-(2′,9′-dimethyl-5′-sulfonate-benzothiazole-1′)morpholine, N-methyl-N-(2′,8′,9′-trimethyl-5′-sulfonate-benzothiazole-1′)morpholine, N-ethyl-N-(2′-methyl-5′-sulfonate-benzothiazole-1′)morpholine, N-ethyl-N-(8′-methyl-5′-sulfonate-benzothiazole-1′)morpholine, N-ethyl-N-(9′-methyl-5′-sulfonate-benzothiazole-1′)morpholine, N-ethyl-N-(2′-ethyl-5′-sulfonate-benzothiazole-1′)morpholine, N-ethyl-N-(8′-ethyl-5′-sulfonate-benzothiazole-1′)morpholine, N-ethyl-N-(9′-ethyl-5′-sulfonate-benzothiazole-1′)morpholine, N-ethyl-N-(2′,8′-dimethyl-5′-sulfonate-benzothiazole-1′)morpholine, N-ethyl-N-(8′,9′-dimethyl-5′-sulfonate-benzothiazole-1′)morpholine, N-ethyl-N-(2′,9′-dimethyl-5′-sulfonate-benzothiazole-1′)morpholine, N-ethyl-N-(2′,8′,9′-trimethyl-5′-sulfonate-benzothiazole-1′)morpholine, N-n-propyl-N-(2′-methyl-5′-sulfonate-benzothiazole-1′)morpholine, N-n-propyl-N-(8′-methyl-5′-sulfonate-benzothiazole-1′)morpholine, N-n-propyl-N-(9′-methyl-5′-sulfonate-benzothiazole-1)')morpholine, N-n-propyl-N-(2′-ethyl-5′-sulfonate-benzothiazole-1′)morpholine, N-n-propyl-N-(8′-ethyl-5′-sulfonate-benzothiazole-1′)morpholine, N-n-propyl-N-(9′-ethyl-5′-sulfonate-benzothiazole-1′)morpholine, N-n-propyl-N-(2′,8′-dimethyl-5′-sulfonate-benzothiazole-1′)morpholine, N-n-propyl-N-(8′,9′-dimethyl-5′-sulfonate-benzothiazole-1′)morpholine, N-n-propyl-N-(2′,9′-dimethyl-5′-sulfonate-benzothiazole-1′)morpholine, or N-n-propyl-N-(2′,8′,9′-trimethyl-5′-sulfonate-benzothiazole-1′)morpholine.

In one or more embodiments, the electrolyte additive includes a compound of Formula (1):

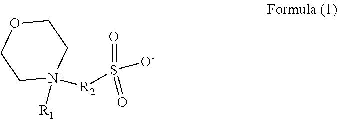

wherein R₁ is a C₁₋₃ alkyl group substituted with a halogen or a C₁₋₃ alkyl group.

In one or more embodiments of the present application, the electrolyte additive of the present application includes one of the following substituted or unsubstituted compounds or any combination thereof: N-chloromethyl-N-(3-methanesulfonate)morpholine, N-dichloromethyl-N-(3-methanesulfonate)morpholine, N-trichloromethyl-N-(3-methanesulfonate)morpholine, N-fluoromethyl-N-(3-methylsulfonate)morpholine, N-difluoromethyl-N-(3-methylsulfonate)morpholine, N-trifluoromethyl-N-(3-methanesulfonate) morpholine, N-fluoroethyl-N-(3-methanesulfonate)morpholine, N-fluoro-n-propyl-N-(3-methanesulfonate)morpholine, N-fluoro-isopropyl-N-(3-methanesulfonate)morpholine, N-fluoromethyl-N-phenylmorpholine p-sulfonate, N-fluoroethyl-N-phenylmorpholine p-sulfonate, N-fluoro-n-propyl-N-phenylmorpholine p-sulfonate, N-fluoromethyl-N-benzothiazomorpholine p-sulfonate, N-fluoroethyl-N-benzothiazoline p-sulfonate, or N-fluoro-n-propyl-N-benzothiazoline p-sulfonate.

In a further embodiment, the electrolyte additive includes a compound of Formula (1):

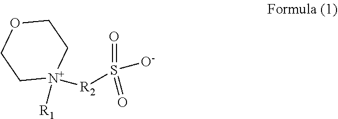

wherein R₂ is selected from the group consisting of C₁₋₆ alkylene groups, C₁₋₆ alkylene groups substituted with a halogen or a C₁₋₃ alkyl group, phenylene group, phenylene groups substituted with a halogen or a C₁₋₃ alkyl group, benzothiazolylene group, and benzothiazolylene groups substituted with a halogen or a C₁₋₃ alkyl group.

In one or more embodiments, the electrolyte additive of the present application includes one or any combination of N-methyl-N-(3-chloromethanesulfonate)morpholine, N-methyl-N-(3-fluoromethanesulfonate)morpholine, N-methyl-N-(3-fluoroethanesulfonate)morpholine, N-methyl-N-(3-fluoropropanesulfonate)morpholine, N-methyl-N-(2′-chloro-4′-sulfonate-phenyl-1′)-morpholine, N-methyl-N-(2′-fluoro-4′-sulfonate-phenyl-1′)-morpholine, N-methyl-N-(2′-methyl-3-fluoro-4′-sulfonate-phenyl-1′)-morpholine, N-methyl-N-(2′-fluoro-3-fluoro-4′-sulfonate-phenyl-1′)-morpholine, N-methyl-N-(2′-methyl-5′-sulfonate-benzothiazole-1′)morpholine, N-methyl-N-(2′-fluoro-5′-sulfonate -benzothiazole-1′)morpholine, N-methyl-N-(2′,8′-difluoro-5′-sulfonate-benzothiazole-1′)morpholine, or N-methyl-N-(2′-fluoro-8′-methyl-5′-sulfonate-benzothiazole-1′)morpholine.

In a preferred embodiment, the electrolyte additive includes one of the following compounds or any combination thereof:

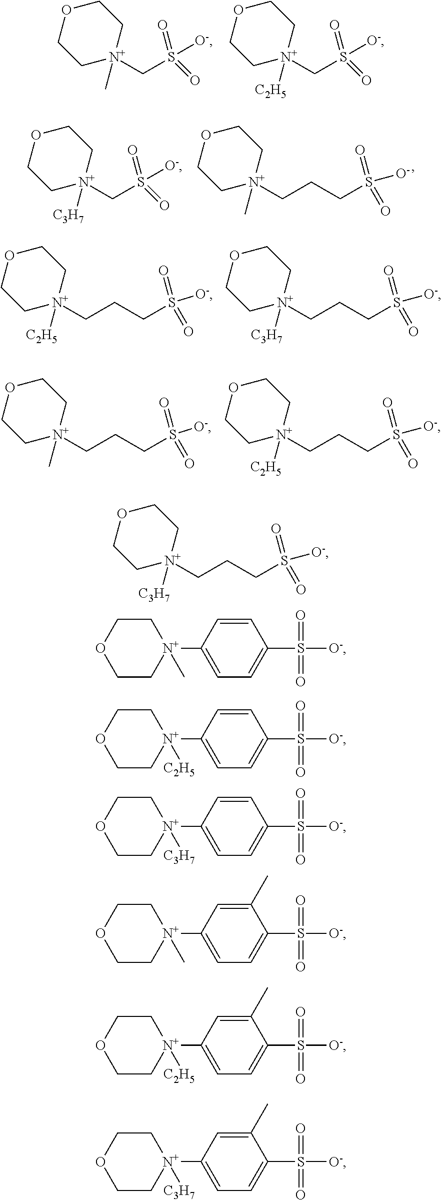

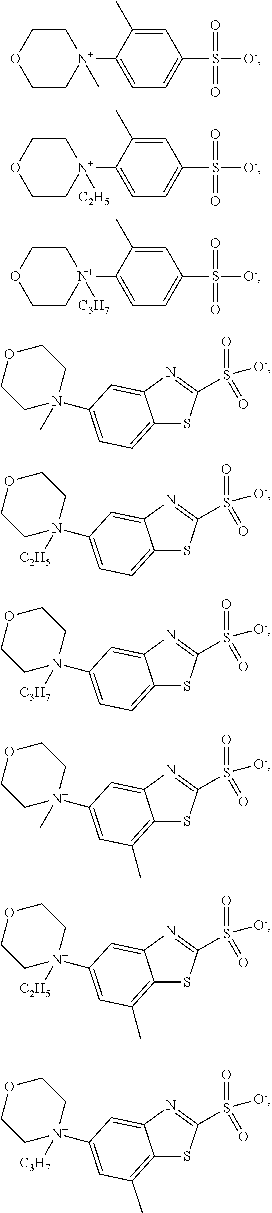

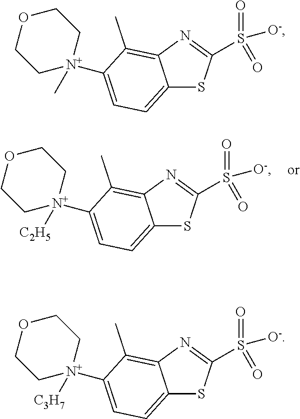

In an embodiment, the electrolyte additive is N-methyl-N-(3-propanesulfonate)morpholine. During the first cycle of a lithium-ion secondary battery including N-methyl-N-(3-propanesulfonate)morpholine, the electrolyte additive undergoes the following reaction: N-methyl-N-(3-propanesulfonate)morpholine is decomposed into a positively charged N-methyl-N-propane moiety and a negatively charged sulfonate moiety under the catalytic action of hydrogen fluoride. The positively charged N-methyl-N-propane moiety is gathered to the positive electrode of the lithium-ion secondary battery under the action of an electric current, and is deposited on the surface of the positive electrode to form a CEI film. The negatively charged sulfonate moiety is gathered to the negative electrode portion of the lithium-ion secondary battery under the action of an electric current, and will react under the action of lithium ions, thereby forming an SEI film with a mesh structure. After the CEI film and the SEI film are formed, both the positive electrode and the negative electrode of the lithium-ion secondary battery are protected, and the dissolution of the transition metal ions is suppressed.

In another embodiment of the present application, the electrolyte additive is N-methyl-N-phenylmorpholine p-sulfonate. During the first cycle of a lithium-ion secondary battery comprising N-methyl-N-phenylmorpholine p-sulfonate, the electrolyte additive undergoes the following reaction: N-methyl-N-phenylmorpholine p-sulfonate is decomposed into a positively charged N-methyl-N-benzene moiety and a negatively charged sulfonate moiety under the catalytic action of hydrogen fluoride. The positively charged N-methyl-N-benzene part is gathered to the positive electrode of the lithium-ion secondary battery under the action of an electric current, and deposited on the surface of the positive electrode to form a CEI film. The negatively charged sulfonate moiety is gathered to the negative electrode portion of the lithium-ion secondary battery under the action of an electric current, and will react under the action of lithium ions, thereby forming an SEI film with a mesh structure. After the CEI film and the SEI film are formed, both the positive electrode and negative electrode of the lithium-ion secondary battery are protected, and the dissolution of the transition metal ions is suppressed.

In an embodiment of the present application, the electrolyte additive is N-methyl-N-benzothiazomorpholine p-sulfonate. During the first cycle of a lithium-ion secondary battery comprising N-methyl-N-benzothiazomorpholine p-sulfonate, the electrolyte additive undergoes the following reaction: N-methyl-N-benzothiazomorpholine p-sulfonate is decomposed into a positively charged N-methyl-N-benzothiazole moiety and a negatively charged sulfonate moiety under the catalytic action of hydrogen fluoride. The positively charged N-methyl-N-benzothiazole moiety is gathered to the positive electrode of the lithium-ion secondary battery under the action of an electric current, and is deposited on the surface of the positive electrode to form a CEI film. The negatively charged sulfonate moiety is gathered to the negative electrode portion of the lithium-ion secondary battery under the action of an electric current, and will react under the action of lithium ions, thereby forming an SEI film with a mesh structure. After the CEI film and the SEI film are formed, both the positive electrode and negative electrode of the lithium-ion secondary battery are protected, and the dissolution of the transition metal ions is suppressed.

In another embodiment, provided is an electrolyte including an organic solvent, a lithium salt, and an electrolyte additive as described herein. As the electrolyte additive is included, the electrolyte can effectively form a CEI film on the surface of the positive electrode and form an SEI film on the surface of the negative electrode during the first cycle of the battery, thereby avoiding the reaction between the solvent and the electrodes, inhibiting the dissolution of metal ions, improving the stability of the electrodes, reducing the impedance of the battery, and improving the cycle retention rate and the rate performance of the battery. In addition, as the electrolyte of the present application includes the electrolyte additive described herein, only one type of electrolyte can be added without adding various additives at the same time to form a solid electrolyte film at the positive electrode and the negative electrode at the same time, and thus the possibility of side reactions between electrolyte additives is eliminated, and the formation of electrolyte and electrode surface impurities can be effectively controlled, and then the battery impedance is reduced.

In one or more embodiments, in the electrolyte, the amount of the electrolyte additive is in the range of 0.1 parts by weight to 1 part by weight based on 100 parts by weight of the total weight of the organic solvent and the lithium salt. As the electrolyte additive of the present application can simultaneously form a CEI film and an SEI film during the first cycle, there is no need to add other film-forming additives. In addition, adding the electrolyte additive in the range described herein can effectively form the electrolyte film. When the amount of the electrolyte additive is less than 0.1 parts by weight, a suitable dense electrolyte film cannot be formed on both the positive electrode and the negative electrode, and when the amount of the electrolyte additive is greater than 1 part by weight, the formed electrolyte film is excessively thick, thereby adversely affecting the cycle efficiency of the lithium-ion secondary battery and disadvantageously increasing the battery impedance.

In one or more embodiments, the minimum amount of the electrolyte additive, depending on various combinations of the lithium salt and the organic solvent, should be greater than 0.1 parts by weight, 0.11 parts by weight, 0.12 parts by weight, 0.13 parts by weight, 0.15 parts by weight, 0.16 parts by weight, 0.17 parts by weight, 0.18 parts by weight, or 0.19 parts by weight, based on the total weight of the organic solvent and the lithium salt. Further, the maximum amount of the electrolyte additive in the electrolyte, depending on various combinations of the organic solvent and the lithium salt, should be less than 1 part by weight, 0.9 parts by weight, 0.8 parts by weight, 0.7 parts by weight, 0.6 parts by weight, 0.5 parts by weight, 0.49 parts by weight, 0.48 parts by weight, 0.47 parts by weight, 0.46 parts by weight, 0.45 parts by weight, 0.44 parts by weight, 0.43 parts by weight, 0.42 parts by weight, 0.41 parts by weight, 0.4 parts by weight, 0.35 parts by weight, 0.3 parts by weight, 0.25 parts by weight, or 0.2 parts by weight based on 100 parts by weight of the total amount of the organic solvent and the lithium salt.

In an embodiment, the amount of the electrolyte additive in the electrolyte may be in the range of 0.1 parts by weight to 1 part by weight, 0.2 parts by weight to 0.9 parts by weight, 0.3 parts by weight to 0.8 parts by weight, 0.4 parts by weight to 0.7 parts by weight, 0.5 parts by weight to 0.6 parts by weight, 0.1 parts by weight to 0.5 parts by weight, 0.1 parts by weight to 0.4 parts by weight, 0.1 parts by weight to 0.3 parts by weight, 0.1 parts by weight to 0.2 parts by weight, 0.1 parts by weight to 0.41 parts by weight, 0.11 parts by weight to 0.4 parts by weight, 0.12 parts by weight to 0.35 parts by weight, 0.13 parts by weight to 0.3 parts by weight, 0.14 parts by weight to 0.25 parts by weight, 0.15 parts by weight to 0.2 parts by weight, 0.15 parts by weight to 0.5 parts by weight, 0.13 parts by weight to 0.5 parts by weight, or 0.12 parts by weight to 0.25 parts by weight, based on 100 parts by weight of the total weight of the organic solvent and the lithium salt.

Any suitable type of components of the lithium salt included in the electrolyte and including applicable to an electrolyte for a lithium battery can be employed. Examples of the lithium salt include, but are not limited to, LiPF₆, LiBF₄, LiAsF₆, LiCF₃SO₃, LiN(SO₂F)₂, LiN(SO₂CF₃)₂, LiC(SO₂CF₃)₃, Li₂SiF₆, or combinations according to an embodiment.

The organic solvent of the nonaqueous electrolyte may be any suitable type of nonaqueous solvent used for nonaqueous electrolytes. Examples include, but are not limited to, linear or cyclic carbonates, such as ethylene carbonate, propylene carbonate, butylene carbonate, diethyl carbonate, dimethyl carbonate, methyl ethyl carbonate, dipropyl carbonate, fluoroethylene carbonate; ethers such as 1,2-dimethoxyethane, 1,2-diethoxyethane, γ-butyrolactone, tetrahydrofuran, 2-methyltetrahydrofuran, 1,3-dioxolane, 4-methyl-1,3-dioxolane, and diethyl ether; sulfones such as sulfolane and methylsulfolane; nitriles such as acetonitrile, propionitrile, and acrylonitrile; and esters such as acetates, propionates, and butyrates. These non-aqueous solvents may be used alone or a plurality of solvents may be used in combination. In one or more embodiments, the the organic solvent includes ethylene carbonate, propylene carbonate, butylene carbonate, fluoroethylene carbonate, diethyl carbonate, dipropyl carbonate, methyl ethyl carbonate, ethylene carbonate and/or dimethyl carbonate, and any combinations thereof. In a preferred embodiment, at least one carbonate ester is used as the organic solvent of the electrolyte. In one or more other preferable embodiments, the nonaqueous solvents described herein may be used in any combination to form an electrolyte complying with specific requirements.

In another embodiment, provided is a lithium-ion secondary battery, including a positive electrode sheet, a negative electrode sheet, a separator, and the foregoing electrolyte. As the lithium-ion secondary battery includes the electrolyte described herein, it has excellent electrode stability, cycle retention, and rate performance.

The positive electrode sheet of the present application, in an embodiment, includes a positive electrode current collector and positive electrode active material layers including a positive electrode active material. The positive electrode active material layer is formed on both surfaces of the positive electrode collector. As the positive electrode current collector, a metal foil such as an aluminum foil, a nickel foil, and a stainless steel foil may be used.

The positive electrode active material layer includes one or two or more of positive electrode materials capable of absorbing and releasing lithium ions and used as positive electrode active materials, and may contain, as necessary, another material such as a positive electrode binder and/or a positive electrode conductive agent.

Preferably, the positive electrode material is a lithium-containing compound. Examples of such lithium-containing compound include lithium-transition metal composite oxides, lithium-transition metal phosphate compounds, and the like. The lithium-transition metal composite oxides are oxides containing Li and one or two or more transition metal elements as constituent elements, and the lithium-transition metal phosphate compounds are phosphate compounds containing Li and one or two or more transition metal elements as constituent elements. Among them, the transition metal element is favorably any one or two or more of Co, Ni, Mn, Fe, and the like.

Examples of the lithium-transition-metal composite oxides include, for example, LiCoO₂, LiNiO₂, and the like. Examples of the lithium-transition metal phosphate compounds include, for example, LiFePO₄, LiFe₁₋ᵤMnᵤPO₄ (0<u<1), and the like.

In one or more embodiments of the present application, the positive electrode material includes a ternary positive electrode material such as nickel cobalt lithium aluminate (NCA) or nickel cobalt lithium manganate (NCM). Specific examples may be NCA, LixNiyCozAl1-y-zO₂ (1≤x≤1.2, 0.5≤y≤1, and 0≤z≤0.5). NCM, LiNixCoyMnzO₂ (x+y+z=1, 0<x<1, 0<y<1, 0<z<1). Specific examples of the positive electrode material may include, but are not limited to LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co _{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13})O₂, LiFePO₄, LiMnPO₄, LiFe_{0.5}Mn_{0.5}PO₄, and LiFe_{0.3}Mn_{0.7}PO₄.

Further, the positive electrode material includes, for example, any one or two or more of oxides, disulfides, chalcogenides, conductive polymers, lithium cobaltate, lithium manganate, nickel cobalt manganese ternary materials, and the like. Examples of the oxides include, for example, titanium oxide, vanadium oxide, manganese dioxide, and the like. Examples of the disulfides include, for example, titanium disulfide, molybdenum sulfide, and the like. Examples of the chalcogenides include niobium selenide and the like. Examples of the conductive polymers include, for example, sulfur, polyaniline, polythiophene, and the like. However, the positive electrode material may be a material different from those described above.

Examples of the positive electrode conductive agent include carbon materials such as graphite, carbon black, acetylene black, and Ketjen black. These may be used alone, or two or more thereof may be used in mixture. It is to be noted that the positive electrode conductive agent may be a metal material, a conductive polymer, or the like as long as it has electrical conductivity.

Examples of the positive electrode binder include, for example, synthetic rubber and a polymeric material. The synthetic rubber may be, for example, styrene-butadiene rubber, fluorine rubber, and ethylene propylene diene. The polymeric material may be, for example, polyvinylidene fluoride, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, lithium polyacrylate, ethylene-propylene-diene terpolymer (EPDM), sulfonated EPDM, and polyimide. These may be used alone, or two or more thereof may be used in mixture.

The negative electrode sheet, in an embodiment, includes a negative electrode current collector and a negative electrode active material layer including a negative electrode active material. The negative electrode active material layer is provided on both surfaces of the negative electrode current collector. As the negative electrode current collector, a metal foil such as a copper (Cu) foil, a nickel foil, and a stainless steel foil may be used.

The negative electrode active material layer includes, as an negative electrode active material, a material capable of absorbing and releasing lithium ions, and may contain, as necessary, another material such as an negative electrode binder and/or an negative electrode conductive agent. Details of the negative electrode binder and the negative electrode conductive agent are the same as those of the positive electrode binder and the negative electrode conductive agent, for example.

The active material of the negative electrode is any one or a combination of more selected from lithium metal, a lithium alloy, a carbon material, silicon or tin, and oxides thereof.

As the carbon material has a low potential when absorbing lithium ions, a high energy density can be obtained, and the battery capacity can be increased. In addition, the carbon material also functions as a conductive agent. Such carbon material is, for example, natural graphite, artificial graphite, a material obtained by coating same with amorphous carbon, or the like. It is noted that the shape of the carbon material is fibrous, spherical, granular, scale-like, or the like. The silicon-based material includes nano silicon, a silicon alloy, and a silicon-carbon composite material formed by compounding SiO_{w} and graphite. Preferably, the SiO_{w} is silicon oxide, silicon oxide, or other silicon-based materials.

Otherwise, the negative electrode material may be, for example, one or two or more of easily graphitizable carbon, hardly graphitizable carbon, metal oxides, polymer compounds, and the like. Examples of the metal oxides include, for example, iron oxide, ruthenium oxide, molybdenum oxide, and the like. Examples of the polymer compounds include, for example, polyacetylene, polyaniline, polypyrrole, and the like. However, the negative electrode material may be another material different from those described herein.

The separator of the present technology serves to separate the positive electrode sheet and the negative electrode sheet in a battery and allow ions to pass therethrough while preventing current short-circuiting due to contact between the two electrode sheets. The separator is, for example, a porous film formed of a synthetic resin, ceramic, or the like, and may be a laminated film in which two or more porous films are laminated. Examples of the synthetic resin include polytetrafluoroethylene, polypropylene, polyethylene, cellulose, and the like.

In an embodiment, when charge is performed, for example, lithium ions are released from the positive electrode and are absorbed in the positive electrode through the nonaqueous electrolyte impregnated in the separator. When discharge is performed, for example, lithium ions are released from the negative electrode and are absorbed in the positive electrode through the nonaqueous electrolyte impregnated in the separator.

In another embodiment, provided is the use of the electrolyte additive described herein for preparing an electrolyte for a lithium-ion secondary battery and/or a lithium-ion secondary battery. After the electrolyte additive of the present application is added to a lithium-ion secondary battery, during the first charge cycle, the electrolyte additive of the present application will decompose preferentially over the electrolyte to produce morpholine radical ions and sulfonate radical ions, and thus a CEI film and an SEI film are respectively formed on the surfaces of the positive electrode and the negative electrode of the lithium-ion secondary battery, thereby effectively avoiding the reaction of the solvent and the electrode, inhibiting the dissolution of metal ions, effectively improving the stability of the electrodes, reducing the impedance of the battery, and improving the cycle retention rate and rate performance of the battery.

The present application will be described in further detail including with reference to the following examples according to an embodiment of the present application.

### EXAMPLE 1

### Preparation of Negative Electrode

Under vacuum and completely dry conditions, at a temperature of 20° C., 94.0 g of a mixture of silicon oxide (SiOₓ, 1<x<2) and graphite powder (the amount of silicon oxide is 9.4 g), 1.9 g of Super-P conductive agent, and 3.15 g of CMC binder (sodium carboxymethylcellulose), and styrene-butadiene rubber SBR (the weight ratio of CMC to SBR is 1:1) were weighed and added to water and stirred evenly to obtain a negative active material slurry. The negative electrode active material slurry was coated on a copper foil to obtain an negative electrode current collector. The negative electrode current collector was dried. An negative electrode sheet was formed using a press forming process.

### Preparation of Positive Electrode

Under vacuum and completely dry conditions, at a temperature of 20° C., 93.0 g of a positive electrode active material nickel cobalt lithium aluminate, 4.0 g of a conductive carbon black, and 3.0 g of polyvinylidene fluoride were mixed to obtain a positive electrode mixture, and the obtained positive electrode mixture was dispersed in N-methylpyrrolidone to obtain a positive electrode mixture slurry. Subsequently, the positive electrode mixture slurry was coated onto an aluminum foil to obtain a positive electrode current collector. The positive electrode current collector was dried. A positive electrode sheet was formed using a press molding process.

### Preparation of Electrolyte

20.0 g of ethylene carbonate, 62.0 g of dimethyl carbonate, and 18.0 g of lithium hexafluorophosphate were mixed to prepare a basic electrolyte. 0.1 g of N-methyl-N-(3-propanesulfonate)morpholine (MSPM) was added to the basic electrolyte to obtain an electrolyte of a battery, wherein the MSPM is represented by the following formula:

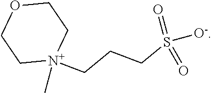

### Assembly of Battery

The CR₂₀₁₆ button battery was assembled in a dry laboratory. The positive electrode sheet prepared in the foregoing steps was used as the positive electrode, and the negative electrode sheet was used as the negative electrode. The positive electrode, the negative electrode, the separator, and a battery housing for a button battery were assembled and the electrolyte was injected. The positive electrode, the negative electrode, the separator, and the battery housing for a button battery were assembled. After the battery was assembled, the battery was allowed to stand for about 24 h aging, so as to obtain a lithium cobalt nickel manganate button battery.

### EXAMPLE 2

A nickel cobalt lithium manganate button battery was prepared by the same method as that in Example 1, except that 0.5 g of MSPM was added to the basic electrolyte to obtain an electrolyte of the battery.

### EXAMPLE 3

A nickel cobalt lithium manganate button battery was prepared by the same method as in Example 1, except that 1.0 g of MSPM was added to the basic electrolyte to obtain an electrolyte of the battery.

### EXAMPLE 4

A nickel cobalt lithium manganate button battery was prepared by the same method as that in example 1, and the difference lies in that 0.1 g of MSIM was added to the basic electrolyte to obtain an electrolyte of the battery, wherein MSIM is as shown in the following formula:

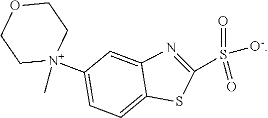

### EXAMPLE 5

A nickel cobalt manganate lithium button battery was prepared by using the same method as that in Example 1, except that 0.5 g of MSIM was added to the basic electrolyte to obtain an electrolyte of the battery.

### EXAMPLE 6

A nickel cobalt lithium manganate button battery was prepared by the same method as in Example 1, except that 1.0 g of MSIM was added to the basic electrolyte to obtain an electrolyte of the battery.

### Comparative Example 1

A nickel cobalt lithium manganate button battery was prepared by the same method as in Example 1, except that no electrolyte additive was added.

### Comparative Example 2

A nickel cobalt lithium manganate button battery was prepared by the same method as that in Example 1, except that 0.05 g of MSPM was added to the basic electrolyte to obtain an electrolyte of the battery.

### Comparative Example 3

A nickel cobalt lithium manganate button battery was prepared by the same method as in Example 1, except that 3.0 g of MSPM was added to the basic electrolyte to obtain an electrolyte of the battery.

### Comparative Example 4

A nickel cobalt manganate lithium button battery was prepared by the same method as that in Example 1, except that 0.05 g of MSIM was added to the basic electrolyte to obtain an electrolyte of the battery.

### Comparative Example 5

A nickel cobalt manganate lithium button battery was prepared by the same method as in Example 1, except that 3.0 g of MSIM was added to the basic electrolyte to obtain an electrolyte of the battery.

### Test of Battery Performance

### Cycle Retention Rate and Post-Cyclic Impedance

The nickel cobalt lithium manganate button batteries of Examples 1-6 and Comparative Examples 1-5 were subjected to charge-discharge test and impedance test at room temperature at a voltage between 3.0 V and 4.2 V. The batteries in the examples and comparative examples above were first subjected to a 0.1 C cycle test at 25° C. once, and then were subjected to a 1 C charge and discharge cycle test at 60° C. for 100 times to determine the cycle retention rate and impedance of the battery. The experimental results are shown in Table 1 below.

| | | | Post-Cyclic |
|---|---|---|---|
| Examples | Additive | Cycle retention | Impedance (Ω) |
| Example 1 | 0.1% MSPM | 68.71% | 31.28 |
| Example 2 | 0.5% MSPM | 75.71% | 28.26 |
| Example 3 | 1% MSPM | 65.69% | 35.09 |
| Example 4 | 0.1% MSIM | 60.84% | 31.73 |
| Example 5 | 0.5% MSIM | 74.27% | 33.29 |
| Example 6 | 1% MSIM | 68.32% | 40.23 |
| Comparative | Not added | 58.70% | 46.18 |
| Example 1 | | | |
| Comparative | 0.05% MSPM | 57.59% | 49.09 |
| Example 2 | | | |
| Comparative | 3% MSPM | 54.83% | 89.22 |
| Example 3 | | | |
| Comparative | 0.05% MSIM | 57.13% | 51.75 |
| Example 4 | | | |
| Comparative | 3% MSIM | 51.26% | 97.03 |
| Example 5 | | | |

It can be determined from the comparison between Examples 1-6 and Comparative Example 1 that the lithium-ion secondary battery using the electrolyte additive of the present technology exhibits remarkably increased cycle retention rate and remarkably reduced post-cycle impedance. As can be determined from the comparison of Example 3 with Comparative Example 2 and the comparison of Example 5 with Comparative Example 4, when the addition amount of the electrolyte additive is less than the range defined in the present application, after the cycling, the impedance is significantly increased, because the amount of the electrolyte additive is insufficient to form a complete dense solid electrolyte film on the surfaces of the positive electrode and the negative electrode, causing dissolution of the transitional elements in the electrode. It can be determined from the comparison between Example 3 and Comparative Example 3 and the comparison between Example 6 and Comparative Example 5 that when the addition amount of the electrolyte additive is larger than the range defined in the present application, the cycle retention rate of the secondary battery is significantly decreased and the impedance after cycling is further increased, because an excessively thick solid electrolyte film is formed on the surfaces of the positive electrode and the negative electrode, thereby reducing the efficiency of lithium intercalation and deintercalation.

### Rate Discharge Test

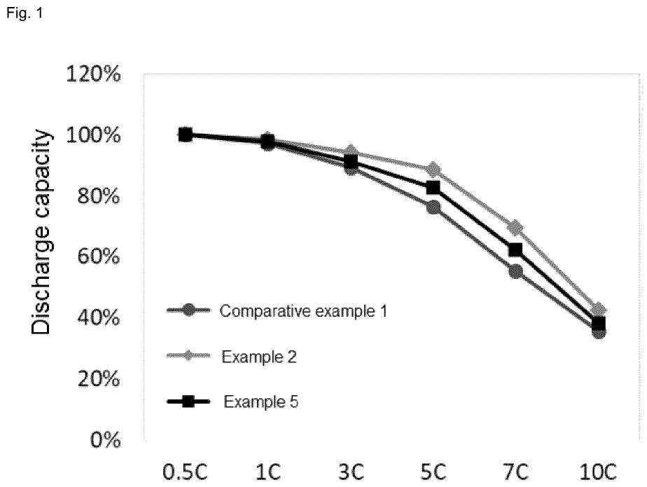

The nickel cobalt lithium manganate button batteries prepared in Example 2, Example 5 and Comparative Example 1 were subjected to 0.5 to 10 C rate discharge test at 25° C., and the test results are shown in FIG. 1.

It can be determined from FIG. 1 that both Example 2 and Example 5 using the electrolyte additive of the present application show excellent rate discharge performance, in which Example 2 can maintain 90% discharge capacity even when performing 5 C rate discharge test.

### Floating Test

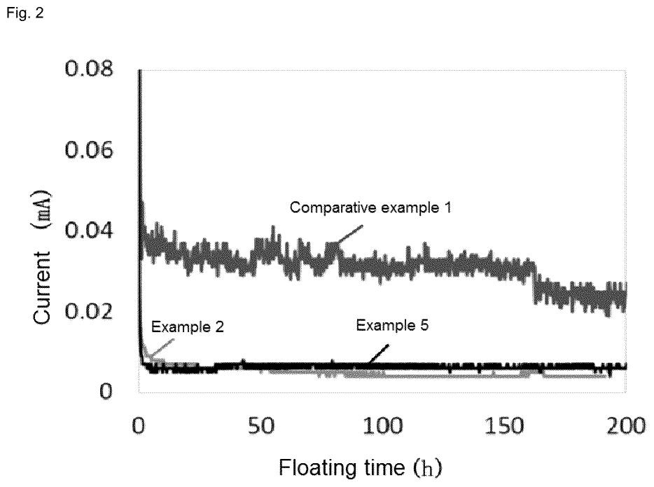

The lithium cobalt nickel manganate button batteries prepared in Example 2, Example 5 and Comparative Example 1 were subjected to a floating test at 25° C., and the test results are shown in FIG. 2.

It can be determined from FIG. 2 that as no electrolyte additive is added in Comparative Example 1, the positive electrode and the negative electrode thereof are not protected by the solid electrolyte film. During the floating test, as the electrode is in direct contact with the electrolyte, the transition metal in the electrode reacts with the electrolyte and is dissolved into the electrolyte, thereby causing an increase in floating charge current. Both Examples 2 and 5 exhibit a much lower floating charge current (almost zero) than Comparative Example 1, indicating that batteries containing 0.5% MSPM or 0.5% MSIM formed a more stable CEI film and SEI film.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An electrolyte additive, comprising a compound as represented by formula (1) as follows: 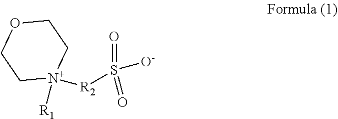
wherein
R₁ is a substituted or unsubstituted C₁₋₆ alkyl group, and
R₂ is selected from the group consisting of a substituted or unsubstituted C₁₋₆ aliphatic hydrocarbylene group and a 6-10 membered substituted or unsubstituted carbocyclic or heterocyclic aromatic group, wherein the heterocyclic aromatic group includes 1 to 3 heteroatoms selected from N, S, O or any combination thereof.

2. The electrolyte additive of claim 1, wherein R₁ is a C₁₋₃ alkyl group substituted with a halogen or a C₁₋₃ alkyl group.

3. The electrolyte additive of claim 1, wherein R₂ is selected from the group consisting of a C₁₋₆ alkylene group, a C₁₋₆ alkylene group substituted with a halogen or a C₁₋₃ alkyl group, a phenylene group, a phenylene group substituted with a halogen or a C₁₋₃ alkyl group, a benzothiazolylene group, and a benzothiazolylene group substituted with a halogen or a C₁₋₃ alkyl group.

4. The electrolyte additive of claim 1, wherein the compound as represented by Formula (1) is any one of:

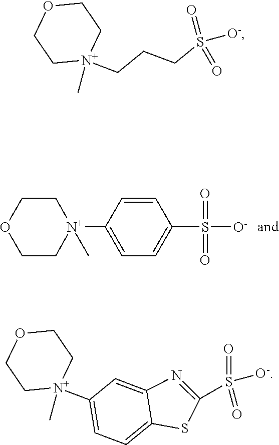

5. An electrolyte, comprising an organic solvent, a lithium salt, and the electrolyte additive of claim 1.

6. The electrolyte of claim 5, wherein an amount of the electrolyte additive is in a range of 0.1 parts by weight to 1 part by weight, based on 100 parts by weight of a total weight of the organic solvent and the lithium salt.

7. The electrolyte of claim 6, wherein the amount of the electrolyte additive is in a range of 0.1 parts by weight to 0.5 parts by weight, based on 100 parts by weight of the total weight of the organic solvent and the lithium salt.

8. The electrolyte of claim 5, wherein the lithium salt is selected from the group consisting of LiPF₆, LiBF₄, LiAsF₆, LiCF₃SO₃, LiN(SO₂F)₂, LiN(SO₂CF₃)₂, LiC(SO₂CF₃)₃, Li₂SiF₆, and any combination thereof.

9. The electrolyte of claim 5, wherein the organic solvent is selected from the group consisting of propylene carbonate, butylene carbonate, fluoroethylene carbonate, diethyl carbonate, dipropyl carbonate, methylethyl carbonate, ethylene carbonate, dimethyl carbonate, and any combination thereof.

10. A lithium-ion secondary battery, comprising:
a positive electrode sheet,
a negative electrode sheet,
a separator, and
the electrolyte of claim 5.

11. A method of preparing an electrolyte for a lithium ion secondary battery, the method comprising providing and utilizing an electrolyte additive to prepare the electrolyte, the electrolyte additive including a compound as represented by formula (1) as follows: 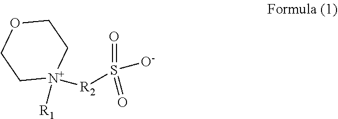
wherein
R₁ is a substituted or unsubstituted C₁₋₆ alkyl group, and
R₂ is selected from the group consisting of a substituted or unsubstituted C₁₋₆ aliphatic hydrocarbylene group and a 6-10 membered substituted or unsubstituted carbocyclic or heterocyclic aromatic group, wherein the heterocyclic aromatic group includes 1 to 3 heteroatoms selected from N, S, O or any combination thereof.

12. A method of manufacturing a lithium ion secondary battery, the method comprising providing and utilizing an electrolyte additive to manufacture the lithium ion secondary battery, the electrolyte additive including a compound as represented by formula (1) as follows: 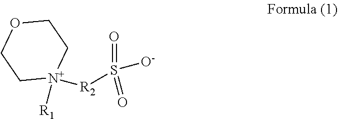
wherein
R₁ is a substituted or unsubstituted C₁₋₆ alkyl group, and
R₂ is selected from the group consisting of a substituted or unsubstituted C₁₋₆ aliphatic hydrocarbylene group and a 6-10 membered substituted or unsubstituted carbocyclic or heterocyclic aromatic group, wherein the heterocyclic aromatic group includes 1 to 3 heteroatoms selected from N, S, O or any combination thereof.
